(19) United States
(12) Patent Application Publication
(10) Pub. No.: US 2008/0116170 A1
(43) Pub. Date: May 22, 2008

(54) SELECTIVE METAL WET ETCH COMPOSITION AND PROCESS

(76) Inventors: Sian Collins, Austin, TX (US); William Wojtczak, Austin, TX (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/942,157

(22) Filed: Nov. 19, 2007

Related U.S. Application Data
(60) Provisional application No. 60/866,239, filed on Nov. 17, 2006.

(51) Int. Cl. C23F 1/24; C09K 13/06

(52) U.S. Cl. 216/87; 216/99; 252/79.4

(57) ABSTRACT

Composition and a process using the composition for selectively wet etching metal including depositing metal on a silicon surface; applying energy to cause respective portions of the metal and silicon to form silicide, leaving a quantity of unreacted metal; selectively wet etching the unreacted metal by applying to the unreacted metal a composition including HCl, HBr, an ammonium halide, an amine hydrohalide salt, a quaternary ammonium halide, a quaternary phosphonium halide or a mixture of any two or more thereof; a nitrogen oxide compound; a stabilizer for the nitrogen oxide, comprising a glycol, a glyme, an ether, a polyol or a mixture of any two or more thereof; and water. In one embodiment, the composition includes an ammonium halide, an amine hydrohalide salt, a quaternary ammonium halide, a quaternary phosphonium halide or a mixture of any two or more thereof; a nitrogen oxide compound; and water.

### CROSS-REFERENCE TO RELATED APPLICATION

The present application is related to and claims benefit, under 35 U.S.C. §119(e), of U.S. Provisional Application No. 60/866,239, filed 17 Nov. 2006, the entirety of which is hereby incorporated herein by reference.

### FIELD OF INVENTION

The present invention relates to a selective metal wet etch composition and a process for selectively etching metal relative to surrounding structures and materials. More particularly, the present invention relates to a metal wet etch composition and process for use in, e.g., silicidation reactions in integrated circuit (IC) manufacturing processes for removing un-reacted metal where metal has been deposited for reaction with silicon in a silicide formation process.

### BACKGROUND

Metal wet etch is a critical process step in IC manufacturing and, pertinent herein, in processes for removing un-reacted metal where metal has been deposited for reaction with silicon in a silicide formation process. Device construction is a multi-step repetitive process of lithography, etch, fill and removal of selected portions of the resulting structures. The removal step can be conducted in a number of ways, including, for example, wet etch, dry etch and chemical mechanical polishing. Many compositions and methods are known for wet etching of metals in a variety of situations in IC manufacturing. In general such methods employ an acid or a base, together with an oxidant such as hydrogen peroxide and water. Many known metal wet etch compositions suffer from low stability and low etch rates on certain metals.

A continuing problem in the metal wet etch art is the selectivity or lack thereof of the various etchants for the metal relative to surrounding structures and materials. When wet etchants are non-selective or have poor selectivity, there can be significant collateral damage to such surrounding structures and materials. As device dimensions become smaller and smaller, the problem of such collateral damage becomes more and more significant and the margin for tolerance of such collateral damage rapidly becomes much lower.

Accordingly, this continuing problem has resulted in a continuing, long-felt need for metal wet etch compositions and processes which provide one or more benefits of being stable, providing relatively high etch rates and being more selective for the target metal with respect to the surrounding structures and materials.

### SUMMARY

Metal wet etch is a critical process step in integrated circuit manufacturing. Device construction is a multi-step repetitive process of lithography, etch, fill, and selective removal. The removal step can be conducted in various ways such as dry etch, wet etch and CMP. A specific application for selective metal wet etch is in silicide formation in the Front End of Line Process of transistor construction. A metal film such as Ti, Ni, Ni(Pt), Co, Pt, or Ru (or other known refractory metals used for silicides, including W, Mo, Nb, Ta and Re) is deposited on silicon or polysilicon. As known in the art, Ni(Pt) is an alloy of nickel and about 3 to about 5 percent platinum. The surface is then heated to induce a reaction between the metal and silicon or polysilicon generating the metal silicide (e.g., NiSi, PtSi, TiSi₂, CoSi₂, RuSi). After silicide formation, excess or unreacted metal on the silicide or other surfaces needs to be removed. Wet etch chemicals that remove the unreacted metal need to be selective to the underlying silicide and to other adjacent or nearby exposed structures, formed of such materials as silicon, doped silicon, polysilicon, doped polysilicon, Silicon-Germanium (SiGe), silicon dioxide, silicon nitride and other materials which may be present. In one embodiment, the chemistry disclosed herein allows facile and selective removal of metals at process conditions including a temperature in the range of about 25° C. to about 60° C.

The present invention addresses and provides a solution to the problem of selective metal wet etch compositions and methods, and thus addresses the long-felt need for metal wet etch compositions and processes which provide one or more of the sought benefits of being stable, providing relatively high etch rates and being more selective for the target metal with respect to the surrounding structures and materials.

Accordingly, in one embodiment, the present invention relates to a process for selectively wet etching a metal comprising depositing a metal on a silicon surface; applying energy to cause respective portions of the metal and the silicon to react together to form a silicide, leaving a quantity of unreacted metal; selectively wet etching the unreacted metal by applying to the unreacted metal a composition comprising an ammonium halide, an amine hydrohalide salt, a quaternary ammonium halide, a quaternary phosphonium halide or a mixture of any two or more thereof; a nitrogen oxide compound; and water.

In one embodiment, the present invention relates to a process for selectively wet etching a metal comprising depositing a metal on a silicon surface; applying energy to cause respective portions of the metal and the silicon to react together to form a silicide, leaving a quantity of unreacted metal; selectively wet etching the unreacted metal by applying to the unreacted metal a composition comprising (a) HCl, HBr, an ammonium halide, an amine hydrohalide salt, a quaternary ammonium halide, a quaternary phosphonium halide or a mixture of any two or more thereof; (b) a nitrogen oxide compound; (c) a stabilizer for the nitrogen oxide, the stabilizer comprising a glycol, a glyme, an ether, a polyol or a mixture of any two or more thereof; and (d) water.

In one embodiment, the composition used in the process is selective to one or more of silicides, polysilicon, silicon, silicon-germanium, nitrides and oxides. In one embodiment, the composition has a selectivity to the one or more silicides, polysilicon, silicon, silicon-germanium, nitrides and oxides in the range from about 10:1 to about 5000:1.

In one embodiment, the nitrogen oxide compound comprises one or more of nitric acid, nitrous acid, nitrosyl tetrafluoroborate, a nitrosyl halide, a nitrite salt, or an organic nitrite compound. Organic nitrites include, e.g., alkyl aralkyl and aryl nitrites.

In one embodiment, the stabilizer for the nitrogen oxide comprises one or more of a diglyme, a triglyme, a tetraglyme, a pentaglyme, a hexaglyme or a mixture of any two or more thereof, a crown ether, or a polyalkylene glycol, a polyalkylene glycol monoalkyl ether, a polyalkylene glycol dialkyl ether or a mixture of any two or more thereof, wherein the alkylene and alkyl groups are C₁ to about C₈ alkylene or alkyl.

In one embodiment, the composition for use in the process further comprises one or more of an alkyl or aryl mono- or poly-sulfonic acid, sulfuric acid, phosphoric acid, or a carboxylic acid.

In one embodiment, the present invention relates to a selective metal wet etch composition comprising an ammonium halide, an amine hydrohalide salt, a quaternary ammonium halide, a quaternary phosphonium halide or a mixture of any two or more thereof; a nitrogen oxide compound; and water.

In another embodiment, the present invention relates to a selective metal wet etch composition comprising (a) HCl, HBr, an ammonium halide, an amine hydrohalide salt, a quaternary ammonium halide, a quaternary phosphonium halide or a mixture of any two or more thereof; (b) a nitrogen oxide compound; (c) a stabilizer for the nitrogen oxide, the stabilizer comprising a glycol, a glyme, an ether, a polyol or a mixture of any two or more thereof; and (d) water.

In another embodiment, the present invention relates to a process for forming a silicide, comprising depositing a metal on a silicon surface; applying energy to cause respective portions of the metal and the silicon surface to react together to form a silicide, leaving a quantity of unreacted metal; selectively wet etching the unreacted metal by applying to the unreacted metal a composition comprising (a) HCl, HBr, an ammonium halide, an amine hydrohalide salt, a quaternary ammonium halide, a quaternary phosphonium halide or a mixture of any two or more thereof; (b) a nitrogen oxide compound; (c) a stabilizer for the nitrogen oxide, the stabilizer comprising a glycol, a glyme, an ether, a polyol or a mixture of any two or more thereof; and (d) water.

In another embodiment, the present invention relates to a process for selectively wet etching a metal associated with a silicide, comprising forming a silicide by reaction of silicon and a metal, wherein the forming leaves a quantity of unreacted metal associated with the silicide; selectively wet etching the unreacted metal by applying to the unreacted metal a composition comprising (a) HCl, HBr, an ammonium halide, an amine hydrohalide salt, a quaternary ammonium halide, a quaternary phosphonium halide or a mixture of any two or more thereof; (b)a nitrogen oxide compound; (c) a stabilizer for the nitrogen oxide, the stabilizer comprising a glycol, a glyme, an ether, a polyol or a mixture of any two or more thereof; and (d) water.

In one embodiment, the unreacted metal, remaining from the silicidation reaction, is one or more of Ti, Ni, Ni(Pt), Co, Pt, Ru, W, Mo, Nb, Ta and Re. These metals, and any other metal known for use in forming silicides, may be the object of the selective wet etching composition of the present invention.

The present invention addresses the continuing, long-felt need for metal wet etch compositions and processes. The compositions and processes of the present invention provide one or more benefits of being stable, providing relatively high etch rates and being more selective for the target metal with respect to the surrounding structures and materials.

### BRIEF DESCRIPTION OF THE DRAWINGS

FIGS. 1-4 depict schematically a process of semiconductor fabrication including formation of a silicide and removal of unreacted metal from the resulting structure, in accordance with an embodiment of the present invention.

FIGS. 5 and 6 are graphical representations of exemplary etch rates for two wet etch formulations in accordance with embodiments of the present invention.

FIG. 7 is a graphical representation of shelf life testing results for a wet etch formulation in accordance with an embodiment of the present invention.

FIG. 8 is a graphical representation of bath life tests at 50° C. for a wet etch formulation in accordance with an embodiment of the present invention.

FIGS. 9 and 10 are graphical representations of exemplary etch rates for a wet etch formulation in accordance with an embodiment of the present invention.

It should be appreciated that for simplicity and clarity of illustration, elements shown in the Figures have not necessarily been drawn to scale. For example, the dimensions of some of the elements are exaggerated relative to each other for clarity. Further, where considered appropriate, reference numerals have been repeated among the Figures to indicate corresponding elements.

It should be appreciated that the process steps and structures described herein do not form a complete system or process flow for carrying out an etching process, such as would be used in manufacturing a semiconductor device or other device. The present invention can be practiced in conjunction with fabrication techniques and apparatus currently used in the art, and only so much of the commonly practiced materials, apparatus and process steps are included as are necessary for an understanding of the present invention.

### DETAILED DESCRIPTION

Throughout the disclosure and claims, the numerical limits of the disclosed ranges and ratios may be combined, and all intervening values are deemed to be disclosed by the disclosure of the ranges. Throughout the disclosure and claims, any member of a group may be deleted from the group. Throughout the disclosure and claims, all possible combinations of the various disclosed elements may be combined, and all such combinations are deemed to be included within the scope of the present invention. Unless otherwise specified all temperatures are measured in degrees Celsius, all processes are conducted at room or ambient temperature, all pressures are atmospheric.

In one embodiment, the present invention relates to a selective metal wet etch composition comprising an ammonium halide, an amine hydrohalide salt, a quaternary ammonium halide, a quaternary phosphonium halide or a mixture of any two or more thereof; a nitrogen oxide compound; and water. In one embodiment, the composition further comprises a stabilizer for the nitrogen oxide.

Thus, in one embodiment, the present invention relates to a selective metal wet etch composition including, in combination, at least the following:

(a) HCl, HBr, an ammonium halide, an amine hydrohalide salt, a quaternary ammonium halide, a quaternary phosphonium halide or a mixture of any two or more thereof;

(b) a nitrogen oxide compound;

(c) a stabilizer for the nitrogen oxide, comprising a glycol, a glyme, an ether, a polyol or a mixture of any two or more thereof; and

(d) water.

In one embodiment, when used to etch or remove unwanted metals, such as unreacted metals remaining after silicide formation, the composition is selective to one or more of silicides, polysilicon, silicon, silicon-germanium, nitrides and oxides. That is, the composition etches the metal preferentially, i.e., selectively, and either does not etch surrounding structures formed of other materials, or etches such surrounding structures very little relative to the etching of the metal. Such surrounding structures may be formed, for example, of materials such as silicides, polysilicon, silicon, silicon-germanium, nitrides and oxides, any or all of which may be present in a given situation. Of course other materials may be present also. Thus, in one embodiment, the composition has a selectivity to the one or more silicides, polysilicon, silicon, silicon-germanium, nitrides and oxides in the range from about 10:1 to about 5000:1. In another embodiment, the composition has a selectivity to the one or more silicides, polysilicon, silicon, silicon-germanium, nitrides and oxides in the range from about 10:1 to about 3000:1, and in another embodiment, the composition has a selectivity to the one or more silicides, polysilicon, silicon, silicon-germanium, nitrides and oxides in the range from about 10:1 to about 1000:1. With such selectivities, the fabricator need not be overly concerned with the protection of surrounding structures, and is given more freedom in designing products and the process flow by which such products are manufactured. This may enable, for example, a reduced number of process steps.

In one embodiment, the unreacted metal, remaining from the silicidation reaction, is one or more of Ti, Ni, Ni(Pt), Co, Pt, Ru, W, Mo, Nb, Ta and Re. These metals, and any other metal known for use in forming silicides, may be the object of the selective wet etching composition of the present invention.

As disclosed above, the composition comprises, inter alia, a component (a) comprising HCl, HBr, an ammonium halide, an amine hydrohalide salt, a quaternary ammonium halide, a quaternary phosphonium halide or a mixture of any two or more thereof. Thus, in one embodiment, the composition simply includes, as component (a), HCl, HBr or an ammonium halide, such as NH₄F, NH₄Cl or NH₄Br. Here and elsewhere in this disclosure, when reference is made to a halide, any one of the halogens may be used, but generally the halide is one of the more common halides, such as chloride or bromide or fluoride.

In one embodiment, the component (a) comprises one or more of the following: Hydrohalides, Alkyl or alkanol or aryl amine hydrohalides, or quaternary ammonium and phosphonium halides, such as HCl, HBr, Methylamine Hydrochloride or bromide, Dimethylamine Hydrochloride or bromide, Trimethylamine Hydrochloride or bromide, Ethylamine Hydrochloride or bromide, Monoethanolamine Hydrochloride or bromide, Diglycolamine Hydrochloride or bromide, Ammonium Hydrochloride or bromide, Diethanolamine Hydrochloride or bromide, Tetramethydiammonium Dihydrochloride or dihydrobromide, Ethylenediammonium Dihydrochloride or bromide, Benzyltrimethylammonium Chloride or Bromide, Tetrabutylammonium Chloride or Bromide, Tetrapropylammonium Chloride or Bromide, Tetraethylammonium Chloride or Bromide and Tetramethylammonium Chloride or Bromide, Tetrabutylphosphonium Chloride or Bromide, Tetradecyltributylphosphonium Chloride or Bromide, Dodecyltrimethylammmoniun Chloride or Bromide, Trimethylethylammonium Chloride or Bromide, Methyltributylammonium Chloride or Bromide, Methyltriethylammonium Chloride or Bromide, Diethyldimethylammonium Chloride or Bromide, Methyltriphenylphosphonium Chloride or Bromide, Trihexyltetradecylphosphonium Chloride or Bromide, [(CH₃)₃NCH2CH(OH)CH₂N(CH₃)₃]2+ Dichloride or Bromide, 1-Butyl-3-methylimidazolium Chloride or Bromide, [(CH₃)₃NCH₂CH₂CH₂CH₂CH₂CH₂N(CH₃)₃]⁺ Dichloride or Dibromide, or a compound having the following structure:

In one embodiment, component (a) comprises an amine hydrohalide salt. The amine hydrohalide salt may comprise a C₁-C₁₈ alkyl mono- or polyamine, a C₁-C₁₈ alkanol mono- or polyamine or a C₆-C₁₄ aryl mono- or polyamine or a mixture of any two or more thereof, in which each amine may be primary, secondary or tertiary; each amine may comprise any combination of said alkyl, alkanol or aryl groups; the alkyl and alkanol groups may be branched or

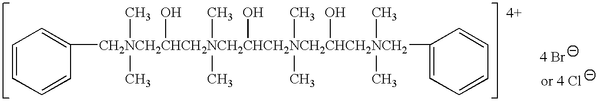

unbranched; and the aryl groups may be substituted with one or more C₁ to C₁₈ alkyl groups.

The monoamines generally contain from 1 up to about 18 carbon atoms, or up to about 12, or up to about 6 carbon atoms. Examples of monoamines include methylamine, ethylamine, propylamine, butylamine, octylamine, and dodecylamine, dimethylamine, diethylamine, dipropylamine, dibutylamine, methyl butylamine, ethyl hexylamine, trimethylamine, tributylamine, methyl diethylamine, ethyl dibutylamine, etc., as known in the art. The arylamines may include, for example, aniline, benzylamine, N-alkyl aniline, N,N-dialkyl aniline, etc. Suitable arylamines include for example, (i) alkyl-substituted aromatic amines, or (ii) hydroxylalkyl-substituted aromatic amines. Suitable arylamines include, for example, phenylenediamine, tolylenediamine, diamino-diphenyl-ether, diamino-diphenyl-methane, diamino-diphenyl-ketone, aminophenyl propanes, aminophenoxy-benzenes, aminophenyl-pentenes, aminobenzylbenzene, diaminoaphthalene, diamino diphenylurea, aminophenoxypheny-benzophenone, dimethyl-aminobenzyl phenoxy benzophenone, diaminohydroxybenzene, dihydroxy-diaminobiphenyl, amino-hydroxyphenyl propanes, and amino-hydroxyphenyl-alkanes.

In one embodiment, the amines may be alkanol amines (also referred to as hydroxyamines), such as those represented by the formulae: H₂NROH, H(R¹)NROH, (R¹)₂NROH, R¹N(ROH)₂ or N(ROH)₃, in which each R¹ is independently a hydrocarbyl group having from one to about eight carbon atoms or hydroxyhydrocarbyl group having from one to about eight carbon atoms, or from one to about four carbon atoms, and R is a divalent hydrocarbyl group of about two to about 18 carbon atoms, or from two to about four carbon atoms. The group R—OH in such formulae represents the alkanol or hydroxyhydrocarbyl group. R can be a cyclic, alicyclic or aromatic group. Typically, R is an acyclic straight or branched alkylene group such as an ethylene, propylene, 1,2-butylene, 1,2-octadecylene, etc. group. The alkanol amine may be primary, secondary, or tertiary alkanol amines having one or more alcohol functional groups. Examples of alkanol amines containing one alcohol functional group include monoethanolamine (MEA), isopropanolamine, N-dimethylethanolamine, N-diethyl ethanolamine, N-dimethyl isopropanol amine and N-diethyl isopropanolamine. Examples of secondary and tertiary alkanol amines having 2 or 3 alcohol functional groups include, for example, diethanolamine (DEA), N-methyldiethanolamine, N-ethyl diethanolamine, diisopropanolamine, triethanolamine (TEA), and triisopropanolamine. Mixtures of alkanol amines may be utilized in forming the salts of the aliphatic dicarboxylic acids, and mixtures of mono, di and/or trialkanol amines also may be utilized.

In one embodiment, the amine may be a polyamine or any N-alkyl mono- or poly-substituted polyamine. The polyamines include, for example, diamines, alkylenepolyamines, hydroxy containing polyamines, condensed polyamines and heterocyclic polyamines, and N-alkyl derivatives thereof. Such alkylenepolyamines include methylenepolyamines, ethylenepolyamines, butylenepolyamines, propylenepolyamines, pentylenepolyamines, etc. The higher homologs and related heterocyclic amines, such as piperazines and N-amino alkyl-substituted piperazines, are also included. Specific examples of such polyamines are ethylenediamine, triethylenetetramine, tris-(2-aminoethyl)amine, propylenediamine, trimethylenediamine, tripropylenetetramine, triethylenetetraamine, tetraethylenepentamine, hexaethyleneheptamine, pentaethylenehexamine, etc. Higher homologs obtained by condensing two or more of the above-noted alkylene amines are similarly useful as are mixtures of two or more of the above described polyamines. As noted, any of the foregoing polyamines may be N-alkyl derivatives of the respective polyamine. In such an embodiment, the alkyl group may be C₁ to about C₁₂ alkyl, branched or unbranched.

In one embodiment, component (a) comprises a quaternary ammonium halide. In one embodiment, the quaternary ammonium halide comprises a tetraalkyl quaternary ammonium halide, a trialkylaryl quaternary ammonium halide, a dialkyldiaryl quaternary ammonium halide, an alkyltriaryl quaternary ammonium halide or a mixture of any two or more of any of the foregoing, in which the alkyl groups independently may be branched or unbranched C₁ to C₁₈ alkyl groups and the aryl groups independently may be C₆-C₁₄ aryl, and the aryl groups may be substituted with one or more C₁ to C₁₈ alkyl groups.

In one embodiment, the quaternary ammonium halide may be a polyquaternary ammonium halide, comprising from 2 to about 6 quaternary ammonium atoms, wherein each quaternary ammonium atom may be separated from adjacent quaternary ammonium atom by a C₁-C₆ alkylene or hydroxyalkylene group.

In one embodiment, component (a) comprises a quaternary phosphonium halide. In one embodiment, the quaternary phosphonium halide comprises a tetraalkyl quaternary phosphonium halide, a trialkylaryl quaternary phosphonium halide, a dialkyldiaryl quaternary phosphonium halide, an alkyltriaryl quaternary phosphonium halide or a mixture of any two or more thereof, wherein the alkyl groups independently may be branched or unbranched C₁ to C₁₈ alkyl groups and the aryl groups independently may be C₆-C₁₄ aryl, and the aryl groups may be substituted with one or more C₁ to C₁₈ alkyl groups.

In one embodiment, the quaternary phosphonium halide may be a polyquaternary phosphonium halide, comprising from 2 to about 6 quaternary phosphonium atoms, wherein each quaternary phosphonium atom may be separated from adjacent quaternary phosphonium atom by a C₁-C₆ alkylene or hydroxyalkylene group.

The quaternary ammonium and quaternary phosphonium halides (onium halides) may be characterized by the general formula:

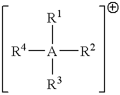

wherein A is a nitrogen or phosphorus atom, R¹, R², R³ and R⁴ are each independently alkyl groups containing from 1 to about 20 carbon atoms, hydroxy alkyl or alkoxy alkyl groups containing from 2 to about 20 carbon atoms, aryl groups, or hydroxy aryl groups, or R¹ and R² together with A may form a heterocyclic group provided that if the heterocyclic group contains a C=A group, R³ is the second bond. The onium group will be balanced by appropriate halide anion.

In the foregoing onium ions, the alkyl groups R¹ to R⁴ may be linear or branched, and specific examples of alkyl groups containing from 1 to 20 carbon atoms include methyl, ethyl, propyl, butyl, pentyl, hexyl, heptyl, octyl, isooctyl, nonyl, decyl, isodecyl, dodecyl, tridecyl, isotridecyl, hexadecyl and octadecyl groups. R¹, R², R³ and R⁴ also may be hydroxyalkyl groups such as hydroxyethyl and the various isomers of hydroxypropyl, hydroxybutyl, hydroxypentyl, etc. In one preferred embodiment, R¹ -R⁴ are independently alkyl groups containing one to ten carbon atoms and hydroxyalkyl groups containing from two to three carbon atoms. Specific examples of alkoxyalkyl groups include ethoxyethyl, butoxymethyl, butoxybutyl, etc. Examples of various aryl and hydroxyaryl groups include phenyl, benzyl, and equivalent groups wherein benzene rings have been substituted with one or more hydroxy groups.

The quaternary ammonium halides which can be used in accordance with the present invention may be represented by the formula:

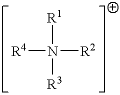

wherein R¹ to R⁴ are as defined in Formula II. In one embodiment, R¹ to R⁴ are alkyl groups independently containing from 1 to about 4 carbon atoms and hydroxyalkyl groups independently containing 2 or 3 carbon atoms. In one embodiment, the quaternary ammonium halides are tetramethylammonium halides or tetraethylammonium halides. Specific examples of other such halides include tetramethylammonium, tetraethylammonium, tetrapropylammonium, tetrabutylammonium, tetra-n-octylammonium, trimethylhydroxyethylammonium, trimethylmethoxyethylammonium, dimethyidihydroxyethylammonium, methyltrihydroxyethylammonium, phenyltrimethylammonium, phenyltriethylammonium, benzyltrimethylammonium, benzyltriethylammonium, dimethylpyrolidinium, dimethylpiperidinium, diisopropylimidazolinium, N-alkylpyridinium, etc., halides

The quaternary phosphonium halides which can be used in accordance with the present invention may be represented by the formula:

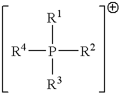

wherein R¹ to R⁴ are as defined in Formula II. In one embodiment, R¹ to R⁴ are alkyl groups independently containing from 1 to about 4 carbon atoms and hydroxyalkyl groups independently containing 2 or 3 carbon atoms. Examples of quaternary phosphonium halides representative of the above formula in accordance with the process of the present invention include tetramethylphosphonium, tetraethylphosphonium, tetrapropylphosphonium, tetrabutylphosphonium, trimethylhydroxyethylphosphonium, dimethyldihydroxyethylphosphonium, methyltrihydroxyethylphosphonium, phenyltrimethylphosphonium, phenyltriethylphosphonium and benzyltrimethylphosphonium, etc., halides.

As disclosed above, the composition comprises, inter alia, a component (b) comprising a nitrogen oxide compound. In one embodiment, the nitrogen oxide compound comprises one or more of nitric acid, nitrous acid, nitrosyl tetrafluoroborate, a nitrosyl halide, a nitrite salt, an organic nitrite compound. In one embodiment, the component (b) is an onium nitrite. In one such embodiment, the onium group is the same onium group as that provided in the component (a), and in another embodiment the onium nitrite contains an onium group that differs from the onium group in the component (a). The onium group in the onium nitrite may be within the description above for the onium groups used for component (a).

Suitable organic nitrites include, e.g., alkyl, aralkyl and aryl nitrites. Suitable alkyl nitrites include, for example, n-butylnitrite, t-butylnitrite, sec-butyl nitrite. In general the alkyl nitrites may include from 1 to about 12 carbon atoms, and may be branched or unbranched.

The composition in accordance with the present invention further includes (c) a stabilizer for the nitrogen oxide compound. Such nitrogen oxides are known to be highly reactive and to quickly be consumed in an etching process. It has been discovered that addition of a stabilizer, as disclosed herein, can prolong the useful lifetime of the nitrogen oxide in the composition of the present invention.

In one embodiment, the stabilizer for the nitrogen oxide comprises a diglyme, a triglyme, a tetraglyme, a pentaglyme, a hexaglyme or a mixture of any two or more thereof.

In one embodiment, the stabilizer for the nitrogen oxide comprises a crown ether.

In one embodiment, the stabilizer for the nitrogen oxide comprises a polyalkylene glycol, a polyalkylene glycol monoalkyl ether, a polyalkylene glycol dialkyl ether or a mixture of any two or more thereof, wherein the alkylene and alkyl groups are C₁ to about C₈ alkylene or alkyl.

In one embodiment, the stabilizer comprises 18-Crown-6, 15-Crown-5, Triglyme, Tetraglyme, Pentaglyme, Hexaglyme, Tetraethyleneglycol monoalkyl ether, triethyleneglycol monoalkyl ether, Tetraethyleneglycol, Polyethyleneglycol, Polyethyleneglycol dialkyl ethers, Polyethyleneglycol monoalkyl ethers, Polypropyleneglycols and Polypropyleneglycol dialkyl ethers, Polypropyleneglycol monoalkyl ethers or a mixture or combination of any two or more thereof. In the foregoing, the alkyl groups are generally, independently, C₁ to about C₁₈ alkyl, and may be branched or unbranched.

As disclosed herein, in addition to the components (a), (b) and (c), the composition further comprises (d), water.

In one embodiment, the composition further comprises one or more of an alkyl or aryl mono- or poly-sulfonic acid, sulfuric acid, phosphoric acid, or a carboxylic acid. These acids may be present in any suitable concentration and, in one embodiment, one or more of these acids may be present as the primary solvent, at a concentration higher than that of the water, disclosed above as the (d) component of the composition.

In one embodiment, the component (a) is comprised in the selective wet etch composition of the present invention in a range from 0.1 to about 50% by weight (wt. %) of the total composition. In another embodiment, the component (a) is present in a range from about 1 wt. % to about 40 wt. %, and in another embodiment the component (a) is present from about 2 wt. % to about 30 wt. %.

In one embodiment, the component (b) is comprised in the selective wet etch composition of the present invention in a range from 0.1 to about 20 wt. % of the total composition. In another embodiment, the component (b) is present in a range from about 3 wt. % to about 15 wt. %, and in another embodiment the component (b) is present from about 5 wt. % to about 13 wt. %.

In one embodiment, the component (c) is comprised in the selective wet etch composition of the present invention in a range from 0.1 to about 10 wt. % of the total composition. In another embodiment, the component (c) is present in a range from about 1 wt. % to about 7 wt. %, and in another embodiment the component (c) is present from about 3 wt. % to about 5 wt. %.

In one embodiment, water is the only solvent and it makes up the remainder of the selective wet etch composition. In one embodiment, the solvent comprises water and further comprises one or more acid such as a sulfonic acid, sulfuric acid, phosphoric acid, sulfamic acid or a carboxylic acid. In one embodiment, the additional one or more acid does not contain a nitrogen oxide acid, so is different from the nitrogen oxide in component (b). In one embodiment, the additional one or more acid does not contain a halogen. In one embodiment, one or a mixture of these additional acids is the only solvent, and thus makes up the remainder of the selective wet etch composition. In one embodiment, when water and an additional acid are used together as the solvent, the water is present in a range from about 20 to about 70 wt. %, and the additional acid is present in a range from about 1 to about 10 wt. %. In another embodiment, when water and an additional acid are used together as the solvent, the water is present in a range from about 35 to about 60 wt. %, and the additional acid is present in a range from about 3 to about 8 wt. %.

### Processes

In one embodiment, the present invention relates to a process for selectively wet etching a metal including steps of depositing a metal on a silicon surface; applying energy to cause respective portions of the metal and the silicon to react together to form a silicide, leaving a quantity of unreacted metal;

selectively wet etching the unreacted metal by applying to the unreacted metal a composition in accordance with the embodiments of the present invention. Thus, in one embodiment, the process includes applying to the unreacted metal a composition including an ammonium halide, an amine hydrohalide salt, a quaternary ammonium halide, a quaternary phosphonium halide or a mixture of any two or more thereof; a nitrogen oxide compound; and water. In another embodiment, the process includes applying to the unreacted metal a composition including (a) HCl, HBr, an ammonium halide, an amine hydrohalide salt, a quaternary ammonium halide, a quaternary phosphonium halide or a mixture of any two or more thereof; (b) a nitrogen oxide compound; (c) a stabilizer for the nitrogen oxide, comprising a glycol, a glyme, an ether, a polyol or a mixture of any two or more thereof; and (d) water. Of course, in a wet etching process, the etching composition will also come in contact with surfaces of other structures and materials which are not desired to be removed. Thus, the wet etch composition needs to have a high level of selectivity for etching the unreacted metal while avoiding the etching of the other structures and materials not desired to be removed. The wet etch composition may further include a stabilizer for the nitrogen oxide, which improves the useful life of the composition, particularly at elevated temperatures which are frequently encountered in use.

Thus, in one embodiment, the composition is selective to one or more of silicides, polysilicon, silicon, silicon-germanium, nitrides and oxides. In one embodiment, this selectivity to the one or more silicides, polysilicon, silicon, silicon-germanium, nitrides and oxides is in the range from about 10:1 to about 5000:1.

In one embodiment, the present invention relates to a process for forming a silicide, including steps of depositing a metal on a silicon surface; applying energy to cause respective portions of the metal and the silicon surface to react together (that is, with each other) to form a silicide, leaving a quantity of unreacted metal; selectively wet etching the unreacted metal by applying to the unreacted metal a composition in accordance with the above-described embodiments. Thus, in one embodiment, the wet etching composition applied in this process includes (a) HCl, HBr, an ammonium halide, an amine hydrohalide salt, a quaternary ammonium halide, a quaternary phosphonium halide or a mixture of any two or more thereof; (b) a nitrogen oxide compound; (c) a stabilizer for the nitrogen oxide, comprising a glycol, a glyme, an ether, a polyol or a mixture of any two or more thereof; and (d) water.

In one embodiment, the present invention relates to a process for selectively wet etching a metal associated with a silicide, including steps of forming a silicide by reaction of silicon and a metal, wherein the forming leaves a quantity of unreacted metal associated with the silicide; selectively wet etching the unreacted metal by applying to the unreacted metal a composition in accordance with the above-described embodiments. Thus, in this embodiment, the wet etching composition applied in this process includes (a) HCl, HBr, an ammonium halide, an amine hydrohalide salt, a quaternary ammonium halide, a quaternary phosphonium halide or a mixture of any two or more thereof; (b) a nitrogen oxide compound; (c) a stabilizer for the nitrogen oxide, comprising a glycol, a glyme, an ether, a polyol or a mixture of any two or more thereof; and (d) water.

The present invention relates to a wet etching composition and to processes for wet etching a metal, not to chemical mechanical polishing and not to any process or composition which includes or uses an abrasive additive. Thus, in one embodiment, the composition of the present invention is free of any added abrasive, and the process of the present invention is carried out in the absence of any abrasive additive or material. In one embodiment, the composition of the present invention is the only material in contact with the metal to be removed by the selective wet etching process.

In one embodiment, the compositions described herein are substantially free of other added ingredients. That is, in one embodiment, no other ingredients are intentionally added to the composition, other than unavoidable impurities.

In one embodiment, the composition of the present invention is that which results from the combination of the disclosed ingredients, including, for example, salts and/or combinations of the added ions which may be different from the specific combination of ions added as a specific salt.

In one embodiment, the etch rate for the selective metal wet etch composition includes a rate from about 600 angstrom (Å)/minute to about 10,000 Å/min. for unreacted metal and rates from about 0 Å/minute to about 25 Å/minute for structures and materials not intended to be removed. In another embodiment, the etch rate for the selective metal wet etch composition includes a rate from about 1000 angstrom (Å)/minute to about 10,000 Å/min. for unreacted nickel and rates from about 5 Å/minute to about 200 Å/minute for platinum, and a rate from about 0 Å/minute to about 1 Å/minute for NiSi, nickel silicide. In one embodiment, the etch rate for the silicide is not detectable.

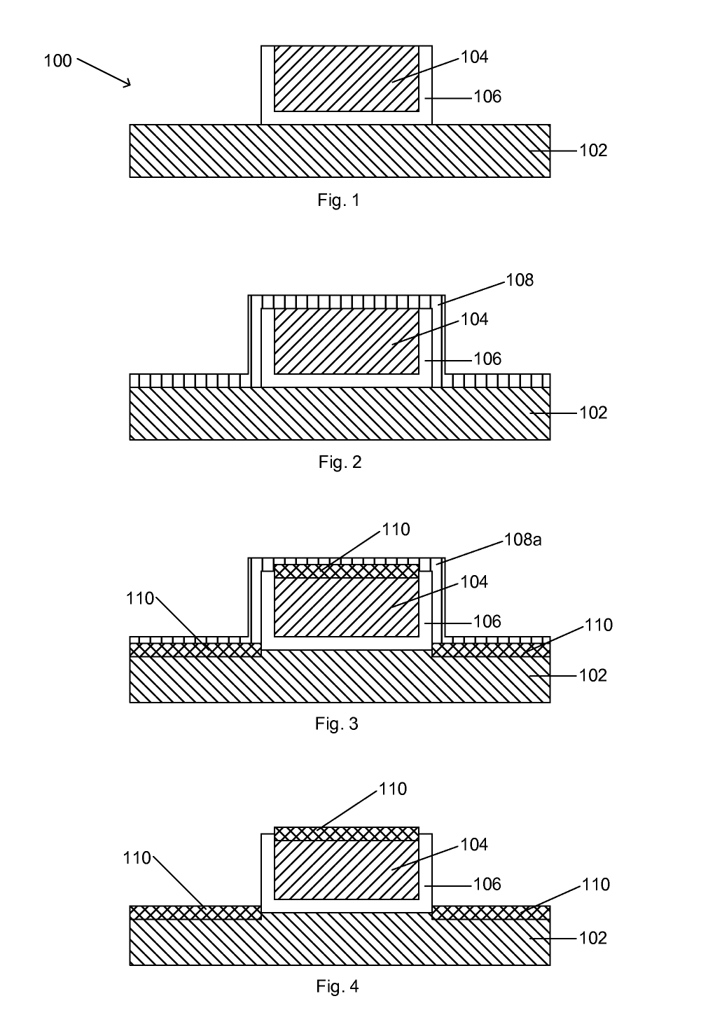

Referring now to FIGS. 1-4, a process in accordance with one embodiment of the present invention is described. FIGS. 1-4 depict schematically a process of semiconductor fabrication including formation of a silicide and removal of unreacted metal from the resulting structure, in accordance with an embodiment of the present invention.

FIG. 1 depicts a nascent semiconductor device 100, including a substrate 102 formed, e.g., of silicon, polysilicon or doped silicon (e.g., for a source and drain), an oxide layer and sidewall spacer 104 and a gate electrode 106, formed, e.g., of silicon, polysilicon or doped silicon. The device 100 may have been fabricated by any appropriate method known in the art, up to this point.

FIG. 2 depicts the device 100 following a step of depositing a metal layer 108 over the surface of the device 100, i.e., on a silicon surface of the device. The metal layer 108 may be deposited by any known method, such as sputtering, various CVD methods, PVD, ALD, etc., as known in the art. As noted above, the metal is intended to form a silicide, so that it may be a refractory metal or any of the metals specifically mentioned above.

FIG. 3 depicts the device 100 following a step of applying energy to cause a portion of the metal layer 108 to react with a portion of the silicon in the areas of the substrate 102 and the gate electrode 104 with which it is in contact. This reaction forms a silicide layer 110 from a portion of the metal layer 108 and leaves an unreacted metal layer 108a from the portion of the metal layer that did not react with the silicon to form the silicide layer 110. Thus, the device 100 shown in FIG. 3 includes a silicide layer 110 and a layer 108a of unreacted metal. The unreacted metal must be removed.

As may be recognized, the steps of depositing the metal and applying energy to cause a reaction of the metal with the silicon may not necessarily be conducted separately. In some embodiments, the method of depositing the metal may impart sufficient energy that a reaction between the metal and silicon takes place during the deposition of the metal. In such a case, it is most likely that excess metal will be deposited, and so removal of the unreacted excess metal still will be needed.

FIG. 4 depicts the device 100 following a step of selectively wet etching the unreacted metal layer 108a by applying to the unreacted metal a composition in accordance with an embodiment of the present invention. As schematically depicted in FIG. 4, the selective wet etching removes substantially all of the unreacted metal selective to the surrounding structures, leaving the surrounding structures substantially intact and not etched.

### EXAMPLES

Having described a number of embodiments of the overall process and composition of the present invention, the following non-limiting but illustrative examples are provided to further describe and enable those of skill in the art to make and use the present invention.

### Formulation Example A

42% Methylamine Hydrochloride
15% Nitric Acid
3% Tetraglyme
40% Water

To make 100 g of Example A, 42.00 g of methylamine hydrochloride is added to 33.64 g deionized water and 21.38 g nitric acid (70 wt %). The mixture is stirred until dissolved. Then 3.00 g tetraglyme is added and the mixture stirred until clear. A similar procedure is used for the following Examples.

### Formulation Example B

40% Trimethylamine Hydrochloride
15% Nitric Acid
3% Tetraglyme
42% Water

### Formulation Example C

30% Trimethylamine Hydrochloride
12% Nitric Acid
5% Tetraglyme
53% Water

### Formulation Example D

3% Tetramethylammonium Chloride
5% Nitric Acid
55% Methanesulfonic Acid
5% Tetraglyme
37% Water

### Formulation Example E

1% HCl
5% Nitric Acid
55% Methanesulfonic Acid
5% Tetraglyme
34% Water

### Formulation Example F

40% Ethylamine Hydrochloride
15% Nitric Acid
3% Tetraglyme
42% Water

### Formulation Example G

40% Trimethylamine Hydrochloride
15% Nitric Acid
3% Tetraethylene glycol
42% Water

### Formulation Example H

2% Methanesulfonic Acid
40% Trimethylamine Hydrochloride
15% Nitric Acid
3% Tetraglyme
40% Water

### Formulation Example 1

40% Trimethylamine Hydrochloride
15% Nitric Acid
5% Tetraglyme
40% Water

### Formulation Example J

40% Methylamine Hydrochloride
15% Nitric Acid
2% Tetraglyme
45% Water

### Formulation Example K

40% Methylamine Hydrochloride
13% Nitric Acid
3% Tetraglyme
44% Water

### Formulation Example L

### No Stabilizer

41.2% Methylamine Hydrochloride
13.4% Nitric Acid
45.4% Water

### Formulation Example M

### No Stabilizer

45% Trimethylamine Hydrochloride
15% Nitric Acid
40% Water

### Formulation Example N

20% Methylamine Hydrochloride
12% Nitric Acid
3% Tetraglyme
65% Water

### Formulation Example O

15% Ammonium chloride
20% Nitric Acid
5% Tetraglyme
60% Water

### Formulation Example P

### No Stabilizer

50% Methanesulfonic Acid
2.2% Tetramethylammonium Chloride
10% Nitric Acid
37.8% Water

### Formulation Example Q

### No Stabilizer

50% Trimethylamine Hydrochloride
12% Nitric Acid
38% Water

### Formulation Example R

### No Stabilizer

48% Dimethylamine Hydrochloride
12% Nitric Acid
40% Water

### Formulation Example S

25% Ethylenediamine Dihydrochloride
15% Nitric Acid
3% Tetraglyme
57% Water

### Formulation Example T

40.2% Methylamine Hydrochloride
14.4% Nitric Acid
0.96% 18-Crown-6
44.45% Water

### Formulation Example U

40% Methylamine Hydrochloride
13% Nitric Acid
3% 18-Crown-6
44% Water

### Formulation Example V

40% Methylamine Hydrochloride
13% Nitric Acid
3% Tetraglyme
0.1% Dodecyltrimethylammonium chloride
43.9% Water

Tests are carried out with the foregoing formulations to determine the etch rates and selectivity.

### Experimental Procedure, Formulations A-U:

### Test Films:

Nickel Coupon

Platinum Foil

NiSi Film (200 Å)

Operating temperature range for the etch chemistry examples is from about 25° to about 60° C. The coupons, pieces, or foils are submerged into the etch solutions at temperatures of 40-60° C., without agitation or stirring. The samples are processed for 5-60 minutes, after which they are rinsed with DI water and blown dry with nitrogen. The film thicknesses before and after processing are determined by mapping for metal films using a Tencor RS35c. The metal coupon samples are measured for weight loss and the resulting mass converted into an etch rate using the material's surface area, density and process time. Shelf life is determined by storing in a bottle at ambient conditions, and each composition is tested periodically by etching a metal under the standard operating conditions. Bath life is measured by measuring etching performance of the bath when held at a selected operating temperature, e.g., at 50° C., for the indicated period prior to testing in actually etching a metal sample.

The Examples L, M, P, Q and R lack the stabilizer and have been found to be less stable than the compositions containing the stabilizer. The compositions of Examples L, M, P, Q and R provide selective etching, but, without the stabilizer, the compositions may be less stable and may decompose in a shorter time than the compositions in which the stabilizer is present. For example, compare Examples I and M, which are the same except that Example I includes 5% tetraglyme. The composition in Example I has a useful shelf life of 16 days, while the composition in Example M has a useful shelf life of only 11 days.

### Results:

A comparison of select etch formulations is given in Table 1.

TABLE 1
Select Formulation Tests

| | T (° C.)/ | | T (° C.)/ | | | |
|---|---|---|---|---|---|---|
| Formu- | Time | Pt | Time | Ni | NiSi | Shelf Life |
| lation | (min.) | (Å/min) | (min.) | (Å/min) | (Å/min) | (Days) |
| A | 50/60 | 14 | 50/10 | 4556 | <0.1 | NA |
| B | 50/60 | 29.8 | 50/10 | 1067 | <0.1 | 15 Days |
| C | 50/60 | 4.6 | 50/10 | 594.6 | <0.1 | NA |
| F | 50/60 | 12.6 | 50/10 | 2711 | <0.1 | NA |
| G | 50/60 | 3.3 | 50/10 | 1154 | <0.1 | NA |
| H | 50/60 | 49.8 | 50/10 | 1565 | <0.1 | NA |
| I | 50/30 | 30 | 50/30 | 771 | <0.1 | 16 Days |
| J | 50/30 | 18 | 50/30 | 2436 | <0.1 | NA |
| K | 50/60 | 18 | 50/10 | 3667 | 0.3 | >90 Days |
| L | 50/60 | 42 | 50/10 | 4771 | 2.7 | NA |
| M | 50/60 | 76 | 50/10 | 1303 | NA | 11 Days |
| N | 50/60 | 0 | 50/5 | 1101 | NA | NA |
| O | 50/60 | <1 | 50/10 | 2440 | NA | NA |
| P | 50/60 | 44 | 50/15 | 5300 | NA | NA |
| Q | 50/60 | 27 | 50/10 | 691 | NA | NA |
| R | 50/60 | 6 | 50/10 | 2265 | NA | NA |
| S | 50/60 | 0 | 50/10 | 1881 | NA | NA |
| T | 50/60 | 0.6 | 50/10 | 1278 | NA | NA |
| U | 50/60 | 0 | 50/10 | 893 | NA | NA |

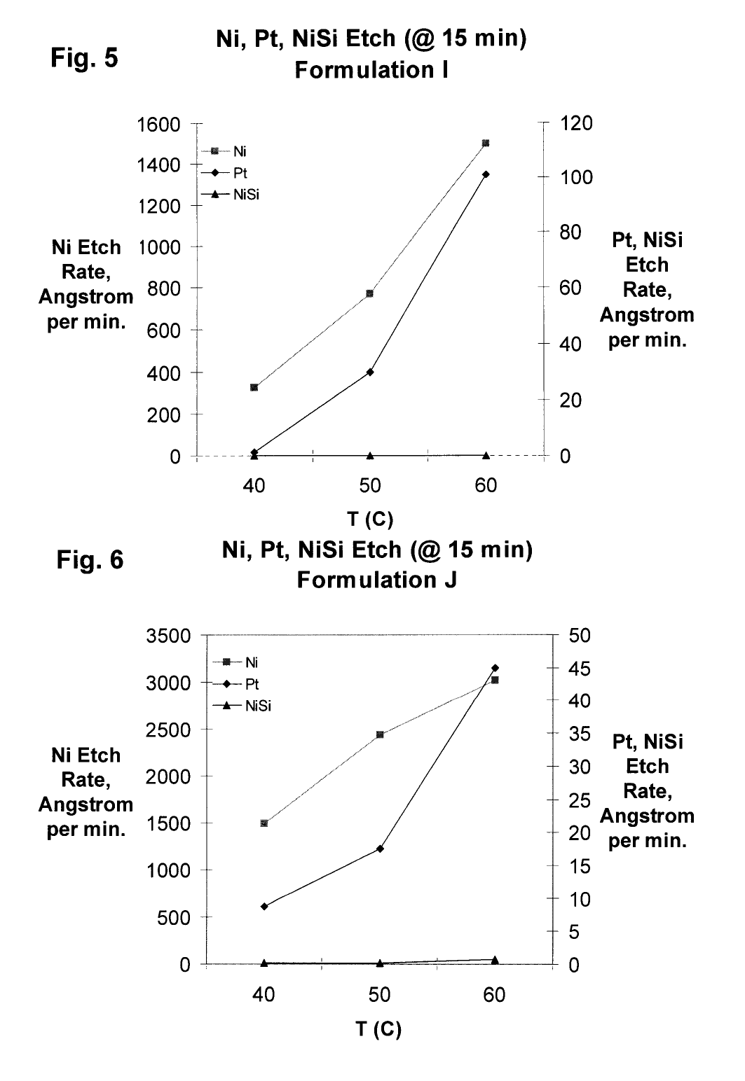

FIGS. 5 and 6 are graphical representations of exemplary etch rates for the above-described Formulations I and J, respectively. As shown by FIGS. 5 and 6, the etch rate for Ni and Pt increases dramatically with temperature, while the etch rate of the NiSi remains quite low, maintaining both the high etch rate and the high selectivity for unreacted metal as compared to the silicide.

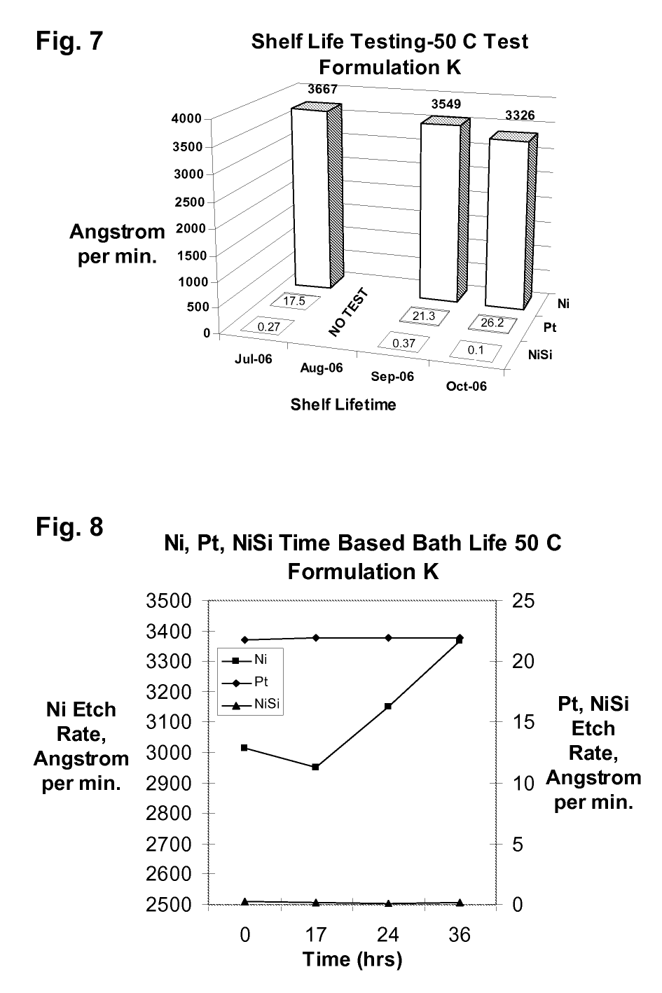

FIG. 7 is a graphical representation of shelf life testing results for the above-described Formulation K. As shown in FIG. 7, the shelf lifetime of a selective wet etch composition in accordance with the present invention is quite good, maintaining both the high etch rate and the high selectivity for unreacted metal as compared to the silicide over a period of several months, even when stored at 50° C.

FIG. 8 is a graphical representation of bath life tests at 50° C. for the above-described Formulation K. As shown in FIG. 8, the bath lifetime of a selective wet etch composition in accordance with the present invention is quite good, maintaining both the high etch rate and the high selectivity for unreacted metal as compared to the silicide over a period of several months, even when the bath is used and maintained at 50° C. for at least 36 hours.

The following tests carried out with Formulation V are similar to the foregoing tests, but are somewhat different in the materials under test and the test conditions.

### Experimental Procedure, Formulation V:

### Test Films:

Ni Film: 10 nm Ni sputtered onto 50 nm oxide/RTP

NiPt Film: 10 nm NiPt sputtered onto 20 nm oxide/RTP

NiSi Film: 10 nm Ni sputtered onto Si/RTP to form NiSi

NiPtSi Film: 10 nm NiPt sputtered onto Si/RTP to form NiPtSi

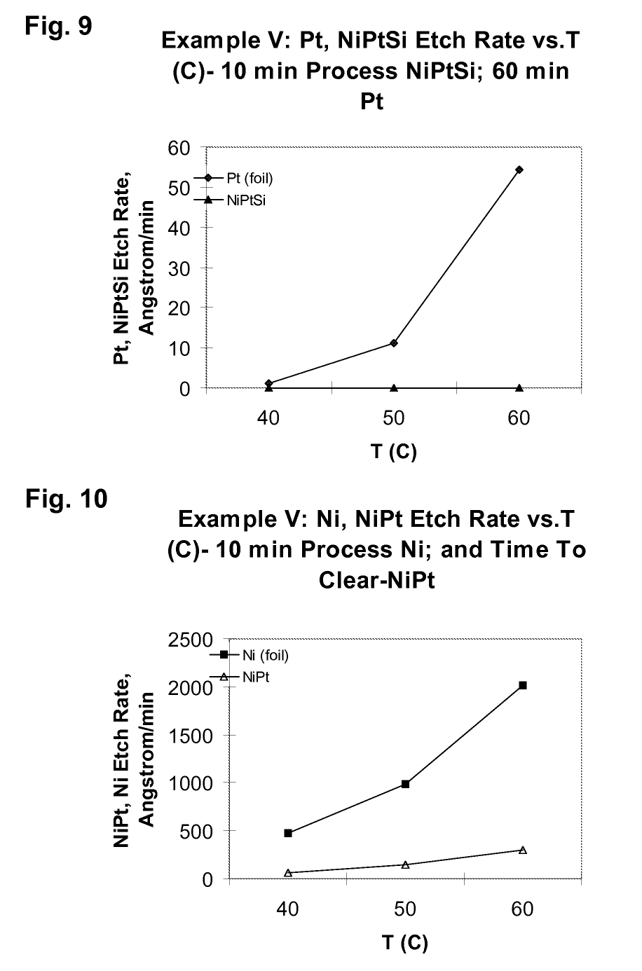

Operating temperature range for the etch chemistry examples is from about 25° to about 60° C. The coupons, pieces, or foils are submerged into the etch solutions at temperatures of 40° C., 50° C. and 60° C., without agitation or stirring. The samples are processed for 10 or 60 minutes or, for NiPt, until all metal is cleared, after which they are rinsed with Di water and blown dry with nitrogen. The NiPtSi pieces are measured at 4 spots by four-point probe to obtain sheet resistance (ohms/sq) using a Tencor RS35c outfitted with a probe head “A”, before and after the metal removal. The resistance change is used to calculate the removal amount and etch rate. The metal samples are measured for weight loss and the resulting mass converted into an etch rate using the material's surface area, density and process time. The results are tabulated in Table 2 and graphically presented in FIGS. 9 and 10.

As shown in Table 2, the Pt etch rate is rather low at 40° C., but increases significantly at higher temperatures. As shown in Table 2 and in FIGS. 9 and 10, this embodiment of the present invention provides excellent selectivity for removing the residual metal, while removing very little, if any, of the silicide.

TABLE 2

| Formulation V | Measurement | 40 C. | 50 C. | 60 C. |
|---|---|---|---|---|
| NiPt Film | Time to Clear | 100/60 | 40/150 | 22/300 |
| | (sec)/Etch Rate | | | |
| | (Å/min) | | | |
| NiPtSi Film | Before Rₛ | 16.58 ± 0.156% | 16.33 ± 0.102% | 17.69 ± 0.244% |
| | (Ohms/Sq.) | | | |
| | After Rₛ | 16.57 ± 0.194% | 16.32 ± 0.141% | 17.68 ± 0.198% |
| | (Ohms/Sq.) | | | |
| Ni Foil | Before Mass (g)/ | 0.9564/ | 0.9512/ | 0.9402/ |
| | After Mass (g) | 0.9511 | 0.9402 | 0.9177 |
| | Calculated Etch | 475 | 986 | 2016 |
| | Rate, Å/min | | | |
| Pt Foil | Before Mass (g)/ | 0.1458/ | 0.1456/ | 0.1438/ |
| | After Mass (g) | 0.1456 | 0.1438 | 0.1350 |
| | Calculated Etch | 1.2 | 11.1 | 54.4 |
| | Rate, Å/min | | | |

FIGS. 9 and 10 are graphical representations of exemplary etch rates for the above-described Formulation V. As shown by FIGS. 9 and 10, the etch rates for Ni, NiPt and Pt increase dramatically with temperature, while the etch rate of the NiPtSi (silicide) remains quite low at all temperatures, which clearly demonstrates both the high unreacted metal etch rates and the high selectivity for unreacted metal as compared to the silicide.

In one embodiment, the composition of the present invention is free of added ferric ions.

In one embodiment, the composition of the present invention is free of added abrasive materials.

In one embodiment, the composition of the present invention is free of added amine oxide surfactant.

In one embodiment, the composition of the present invention is free of added mineral acid other than the nitrogen oxide compound.

In one embodiment, the composition of the present invention is free of added organic acid.

All of the compositions and processes disclosed and claimed herein can be made and executed by those of ordinary skill in the art without undue experimentation in light of the present disclosure and based upon the knowledge of such persons. While the compositions and processes of this invention have been described in terms of certain preferred embodiments, it will be apparent to those of ordinary skill in the art that variations may be applied to the compositions and/or processes and in the steps or in the sequence of steps of the processes described herein without departing from the concept, spirit and scope of the invention. More specifically, it will be apparent that certain agents that are chemically or physiologically related may be substituted for the agents described herein while the same or similar results would be achieved. All such similar substitutes and modifications apparent to those skilled in the art are deemed to be within the spirit, scope and concept of the invention as defined by the appended claims. In addition, notwithstanding that every possible combination of the particularly disclosed embodiments has not been described herein, as will be understood by those of skill in the art, all such combination and permutations are within the scope of the present invention. Thus, every alternative combination of each of the various elements described herein is to be understood as within the scope of the disclosure of the present invention. In addition, in any disclosed list of specific chemical compounds which may be selected for use, any one or more of the specific chemical compounds may be removed from the list, and all such resulting sub-combinations are deemed to be within the scope of the disclosure of the present specification.

1. A process for forming a structure containing a silicide comprising:
forming a silicide by reaction of silicon and a metal, wherein the forming leaves a quantity of unreacted metal associated with the silicide;
selectively wet etching the unreacted metal by applying to the unreacted metal a composition comprising:
an ammonium halide, an amine hydrohalide salt, a quaternary ammonium halide, a quaternary phosphonium halide or a mixture of any two or more thereof;
a nitrogen oxide compound; and
water.

2. The process of claim 1 wherein the forming comprises:
depositing a metal on a silicon surface;
applying energy to cause respective portions of the metal and the silicon to react to form a silicide, leaving the quantity of unreacted metal.

3. The process of claim 1 wherein in the etching, the metal is etched selectively to one or more of silicides, polysilicon, silicon, silicon-germanium, nitrides and oxides with a selectivity in the range from about 10:1 to about 5000:1.

4. The process of claim 1 wherein the amine hydrohalide salt comprises a C₁-C₁₈ alkyl mono- or polyamine, a C₁-C₁₈ alkanol mono- or polyamine or a C₆-C₁₄ aryl mono- or polyamine or a mixture of any two or more thereof, wherein
each amine may be primary, secondary or tertiary;
each amine may comprise any combination of said alkyl, alkanol or aryl groups;
said alkyl and alkanol groups may be branched or unbranched; and
said aryl groups may be substituted with one or more C₁ to C₁₈ alkyl groups.

5. The process of claim 1 wherein the quaternary ammonium halide comprises a tetraalkyl quaternary ammonium halide, a trialkylaryl quaternary ammonium halide, a dialkyldiaryl quaternary ammonium halide, an alkyltriaryl quaternary ammonium halide or a mixture of any two or more thereof, wherein the alkyl groups independently may be branched or unbranched C₁ to C₁₈ alkyl groups and the aryl groups independently may be C₆-C₁₄ aryl, and the aryl groups may be substituted with one or more C₁ to C₁₈ alkyl groups, and wherein the quaternary ammonium halide may be a polyquaternary ammonium halide, comprising from 2 to about 6 quaternary ammonium atoms, wherein each quaternary ammonium atom may be separated from adjacent quaternary ammonium atom by a C₁-C₆ alkylene or hydroxyalkylene group.

6. The process of claim 1 wherein the quaternary phosphonium halide comprises a tetraalkyl quaternary phosphonium halide, a trialkylaryl quaternary phosphonium halide, a dialkyldiaryl quaternary phosphonium halide, an alkyltriaryl quaternary phosphonium halide or a mixture of any two or more thereof, wherein the alkyl groups independently may be branched or unbranched C₁ to C₁₈ alkyl groups and the aryl groups independently may be C₆-C₁₄ aryl, and the aryl groups may be substituted with one or more C₁ to C₁₈ alkyl groups, and wherein the quaternary phosphonium halide may be a polyquaternary phosphonium halide comprising from 2 to about 6 quaternary phosphonium atoms, wherein each quaternary phosphonium atom may be separated from adjacent quaternary phosphonium atom by a C₁-C₆ alkylene or hydroxyalkylene group.

7. The process of claim 1 wherein the nitrogen oxide compound comprises one or more of nitric acid, nitrous acid, nitrosyl tetrafluoroborate, a nitrosyl halide, a nitrite salt, an organic nitrite compound.

8. The process of claim 1 wherein the composition further comprises a stabilizer for the nitrogen oxide, said stabilizer comprising a glycol, a glyme, an ether, a polyol or a mixture of any two or more thereof.

9. The process of claim 8 wherein the stabilizer for the nitrogen oxide comprises a crown ether, a diglyme, a triglyme, a tetraglyme, a pentaglyme, a hexaglyme or a mixture of any two or more thereof.

10. The process of claim 8 wherein the stabilizer for the nitrogen oxide comprises a polyalkylene glycol, a polyalkylene glycol monoalkyl ether, a polyalkylene glycol dialkyl ether or a mixture of any two or more thereof, wherein the alkylene and alkyl groups are C₁ to about C₈ alkylene or alkyl.

11. The process of claim 1 wherein the composition further comprises one or more of an alkyl or aryl mono- or poly-sulfonic acid, sulfuric acid, phosphoric acid, or a carboxylic acid.

12. The process of claim 1 wherein the unreacted metal comprises one or more of Ti, Ni, Ni(Pt), Co, Pt, Ru, W, Mo, Nb, Ta and Re.

13. An abrasive-free selective metal wet etch composition comprising:
(a) HCl, HBr, an ammonium halide, an amine hydrohalide salt, a quaternary ammonium halide, a quaternary phosphonium halide or a mixture of any two or more thereof;
(b) a nitrogen oxide compound;
(c) a stabilizer for the nitrogen oxide, said stabilizer comprising a glycol, a glyme, an ether, a polyol or a mixture of any two or more thereof; and
(d) water.

14. The composition of claim 13 wherein the amine hydrohalide salt comprises a C₁-C₁₈ alkyl mono- or polyamine, a C₁-C₁₈ alkanol mono- or polyamine or a C₆-C₁₄ aryl mono- or polyamine or a mixture of any two or more thereof, wherein
each amine may be primary, secondary or tertiary;
each amine may comprise any combination of said alkyl, alkanol or aryl groups;
said alkyl and alkanol groups may be branched or unbranched; and
said aryl groups may be substituted with one or more C₁ to C₁₈ alkyl groups.

15. The composition of claim 13 wherein the quaternary ammonium halide comprises a tetraalkyl quaternary ammonium halide, a trialkylaryl quaternary ammonium halide, a dialkyldiaryl quaternary ammonium halide, an alkyltriaryl quaternary ammonium halide or a mixture of any two or more thereof, wherein the alkyl groups independently may be branched or unbranched C₁ to C₁₈ alkyl groups and the aryl groups independently may be C₆-C₁₄ aryl, and the aryl groups may be substituted with one or more C₁ to C₁₈ alkyl groups and wherein the quaternary ammonium halide may be a polyquaternary ammonium halide, comprising from 2 to about 6 quaternary ammonium atoms, wherein each quaternary ammonium atom may be separated from adjacent quaternary ammonium atom by a C₁-C₆ alkylene or hydroxyalkylene group.

16. The composition of claim 13 wherein the quaternary phosphonium halide comprises a tetraalkyl quaternary phosphonium halide, a trialkylaryl quaternary phosphonium halide, a dialkyldiaryl quaternary phosphonium halide, an alkyltriaryl quaternary phosphonium halide or a mixture of any two or more thereof, wherein the alkyl groups independently may be branched or unbranched C₁ to C₁₈ alkyl groups and the aryl groups independently may be C₆-C₁₄ aryl, and the aryl groups may be substituted with one or more C₁ to C₁₈ alkyl groups, and wherein the quaternary phosphonium halide may be a polyquaternary phosphonium halide, comprising from 2 to about 6 quaternary phosphonium atoms, wherein each quaternary phosphonium atom may be separated from adjacent quaternary phosphonium atom by a C₁-C₆ alkylene or hydroxyalkylene group.

17. The composition of claim 13 wherein the nitrogen oxide compound comprises one or more of nitric acid, nitrous acid, nitrosyl tetrafluoroborate, a nitrosyl halide, a nitrite salt, an organic nitrite compound.

18. The composition of claim 13 wherein the stabilizer for the nitrogen oxide comprises a crown ether, a diglyme, a triglyme, a tetraglyme, a pentaglyme, a hexaglyme or a mixture of any two or more thereof.

19. The composition of claim 13 wherein the stabilizer for the nitrogen oxide comprises a polyalkylene glycol, a polyalkylene glycol monoalkyl ether, a polyalkylene glycol dialkyl ether or a mixture of any two or more thereof, wherein the alkylene and alkyl groups are C₁ to about C₈ alkylene or alkyl.

20. The composition of claims 13 wherein the composition further comprises one or more of an alkyl or aryl mono- or poly-sulfonic acid, sulfuric acid, phosphoric acid, or a carboxylic acid.

21. A process for forming a structure containing a silicide comprising:
forming a silicide by reaction of silicon and a metal, wherein the forming leaves a quantity of unreacted metal associated with the silicide;
selectively wet etching the unreacted metal by applying to the unreacted metal a composition comprising:
(a) HCl, HBr, an ammonium halide, an amine hydrohalide salt, a quaternary ammonium halide, a quaternary phosphonium halide or a mixture of any two or more thereof;
(b) a nitrogen oxide compound;
(c) a stabilizer for the nitrogen oxide, said stabilizer comprising a glycol, a glyme, an ether, a polyol or a mixture of any two or more thereof; and
(d) water.

22. The process of claim 21 wherein the forming comprises:
depositing a metal on a silicon surface;
applying energy to cause respective portions of the metal and the silicon to react to form a silicide, leaving the quantity of unreacted metal.
